(19) United States
(12) Patent Application Publication
(10) Pub. No.: US 2005/0110447 A1
(43) Pub. Date: May 26, 2005

(54) Device for manipulating the angular position of an object relative to a fixed structure

(76) Inventors: Ulrich Weber, Ulm (DE); Hubert Holderer, Oberkochen (DE); Hartmut Muenker, Hilchenbach-Dahlbruch (DE)

Correspondence Address: Holland & Knight LLP, One East Broward Boulevard, Suite 1300, P.O. Box 14070, Ft. Lauderdale, FL, 33302-4070, US

(21) Appl. No.: 10/942,638

(22) Filed: Sep. 16, 2004

Related U.S. Application Data
(63) Continuation of application No. PCT/EP03/02778, filed on Mar. 18, 2003.

(30) Foreign Application Priority Data
Mar. 21, 2002 (DE) 102 12 547.3

(51) Int. Cl. G05G 11/00; B25J 9/18; B66C 1/00

(52) U.S. Cl. 318/560; 318/568.11; 414/733; 414/729; 74/479.01

(57) ABSTRACT

The invention relates to a device for manipulation of the angular position of an object relative to a fixed structure, into which the object, in particular an optical element of a lens group for microlithography, is introduced, about three rotational axes, intersecting at a point. The object can also be held in a support frame. The support frame, with the object is connected to the fixed structure by means of three connection limbs each with three rotational degrees of freedom and one translational degree of freedom. The angular position of the support frame is adjustable about each one of the three rotational axes by means of one of the connection limbs.

### BACKGROUND OF THE INVENTION

1. Field of the Invention

The invention relates to a device for manipulating the angular position of an object relative to a fixed structure, about three tilt axes intersecting at a point. More particularly, the object may be constituted by an optical element disposed in a microlithographic projection lens.

2. Description of the Related Art

To date, only gimbal bearings for the tilting of an object about three axes intersecting at a point are generally known, in which the tilt axes are divided into a plurality of dividing gears. This necessitates that a plurality of supporting frames, generally one per tilt axis, must be fitted one inside the other, which detrimentally takes up an extraordinary amount of space. For the general state of the art, reference should here be made to JP 000735963.

The dividing gears are also frequently constructed as spring joints. This can lead to the object supported by means of the gimbal bearing being able to be bounced and vibrated relative to the outside world.

In addition, when the dividing gears or springs are fitted one behind the other in the gimbal bearing, the natural frequency at which the object vibrates falls heavily. A minimum natural frequency which is frequently demanded, especially in the field of microlithography, is thus often unattainable.

### SUMMARY OF THE INVENTION

The object of the present invention is therefore to provide a device for tilting an object about three tilt axes intersecting at a point, which device has a very low spatial requirement and allows a very rigid construction and hence a very high natural frequency of the mounted object.

This object is achieved according to claim 1 by the fact that the object is connected to the fixed structure by three tie members, having respectively at least two rotational mobilities and one translational mobility, the angular position of the object being adjustable by, respectively, one of the tie members about, respectively, one of the three tilt axes. According to claim 23, the object is achieved by virtue of the optical element being connected to the fixed structure by three tie members, having respectively at least two rotational mobilities and one translational mobility, the angular position of the optical element being adjustable by, respectively, one of the tie members about, respectively, one of the three tilt axes.

The measures according to the invention allow the object to be tilted in a simple and advantageous manner about three tilt axes intersecting at a point. The device according to the invention can be made in a highly space-saving design, since several supporting frames are able to be eliminated. Furthermore, the device according to the invention produces better rigidity. This prevents unwanted vibrations and, at the same time, gains the natural frequency of the object, which in microlithography is essential. An additional, very substantial advantage is constituted by the good accessibility of the object.

Advantageous designs and refinements of the invention can be obtained from the subclaims and from the illustrative embodiments described in basic terms below with reference to the drawings.

### BRIEF DESCRIPTION OF THE DRAWINGS

FIG. 1 shows a perspective view of the device according to the invention;

FIG. 2 shows a perspective view of an embodiment of a tie member having ball joints, rods and a sliding block;

FIG. 3 shows a perspective view of a monolithic embodiment of a tie member having solid state joints or leaf springs;

FIG. 4a shows a perspective view of a second embodiment of the device according to the invention, having a prism mounted in a supporting frame and a tie member represented in greater detail in FIG. 5;

FIG. 4b shows a further perspective view of the device represented in FIG. 4a;

FIG. 5 shows a perspective view of a further alternative embodiment of a tie member having solid state joints or leaf springs;

FIG. 6 shows a side view of a third embodiment of the device according to the invention, having a prism mounted in a supporting frame;

FIG. 7 shows a perspective view of a fourth embodiment of the device according to the invention, having a prism mounted in a supporting frame and a tie member represented in greater detail in FIG. 8;

FIG. 8 shows a perspective view of a further alternative embodiment of a tie member having solid state joints or leaf springs;

### DETAILED DESCRIPTION

Illustrative embodiments, as can be used in a microlithographic projection lens for the manufacture of semiconductor elements, for example, are described below. A projection lighting system having a projection lens is described, for example, in EP 1022617 A2.

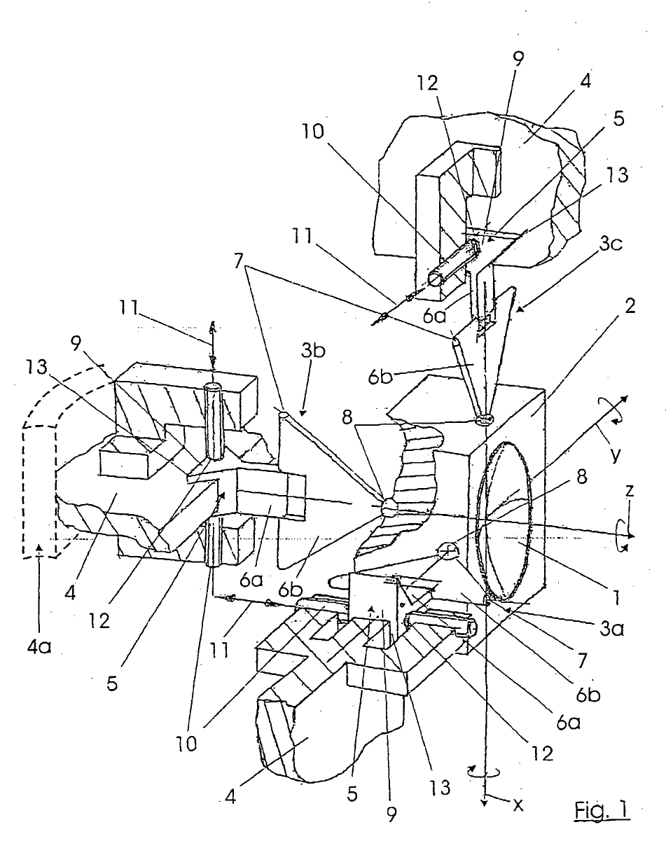

As can be seen from FIG. 1, an object 1 is mounted in a supporting frame 2, which is connected to a fixed structure 4 with three tie members 3a, 3b, 3c respectively, the tie members 3a, 3b, 3c having, as mobilities, three rotations and one translation respectively, and thus the angular position of the supporting frame 2 with the object 1 is adjustable by, respectively, one of the tie members 3a, 3b, 3c about, respectively, a tilt axis x, y or z. The fixed structure 4 is connected to a housing of a projection lens 4a (indicated only in dashed representation in FIG. 1). The object 1 can be, for example, a beam-bending mirror or a prism, what matters being an appropriately precise adjustment.

In FIG. 1 it is indicated that the tilt axes x, y and z intersect at a point.

The of the respective translational mobilities of the three tie members 3a, 3b, 3c are linearly independent from one another.

The x-tilt angle is adjusted by displacement of the tie member 3a, the y-tilt angle by displacement of the tie member 3b and the z-tilt angle by displacement of the tie member 3c. A manipulation of the angular position of the object 1 mounted in the supporting frame 2 about three tilt axes x, y and z intersecting at a point is thus made easily possible.

As can further be seen from FIG. 1, the tie members 3a, 3b, 3c, for the adjustment, respectively, of one of the tilt axes x, y or z, have adjusting mechanisms 5 for the translatory adjustment of at least one part-element 6 of the respective tie members 3a, 3b, 3c. The motional direction of the adjusting mechanisms 5 of the respective tie members 3a, 3b, 3c runs perpendicular to their translational mobility.

Each of the tie members 3a, 3b, 3c has two part-elements 6a, 6b. These are joined together by a hinge 7. The part-element 6b is connected to the supporting frame 2 by a ball joint 8. The part-element 6a facing away from the supporting frame 2 is connected to the fixed structure 4 and can be purposefully moved therein, in a translatory motion, by means of the adjusting mechanisms 5.

As can further be seen from FIG. 1, the adjusting mechanisms 5 have dovetailed sliding blocks 9, which can be purposefully moved, in a translatory motion, by means of adjusting means. The adjusting means 10 can be moved, for example, by manual, motor-driven, hydraulic, electromagnetic, piezoelectric or magnetostrictive means. In the present illustrative embodiment, the adjusting means are configured as setting screws 10. The translational mobility of the setting screws 10 is indicated in FIG. 1 by means of arrows 11.

The center points of the ball joints 8 and the axes of the hinges 7 respectively unfold planes, the translational mobilities of the respective tie members 3a, 3b, 3c being directed perpendicular to the respective planes.

The sliding blocks 9 are provided with contact faces 12 for transmitting the displacement of the setting screws 10 to the sliding blocks 9. The fixed structure 4 has recesses 13, matched in shape and dimensions to the sliding blocks 9, for receiving the sliding blocks 9. The sliding blocks 9 can now be introduced into the recesses 13 in the fixed structure 4 in such a way that they are translatorily adjustable by means of the setting screws 10, which act upon the contact faces 12 of the sliding blocks 9.

It can further be seen from FIG. 1 that the axes of the hinges 7 of each of the tie members 3a, 3b, 3c are respectively disposed at least approximately parallel to the respective translatory motional direction of the adjusting mechanisms 5.

The tie member 3a is disposed such that the point of contact between the tie member 3a and the supporting frame 2 lies in the plane which is unfolded by the y-tilt axis and the z-tilt axis. The translational mobility of the tie member 3a is in this case orientated perpendicular to the plane unfolded by the y and z-tilt axes. The adjustment of the x-tilt angle is effected by displacement of the point of contact between the tie member 3a and the fixed structure 4, the direction of displacement having a component parallel to the plane unfolded by the y and z-tilt axes and not intersecting the x-tilt axis. The displacement is adjusted by the setting screws 10.

The tie member 3b is disposed such that the point of contact between the tie member 3b and the supporting frame 2 lies in the plane unfolded by the z-tilt axis and the x-tilt axis. The translational mobility of the tie member 3b is in this case orientated perpendicular to the plane unfolded by the z and x-tilt axes. The adjustment of the y-tilt angle is effected by displacement of the point of contact between the tie member 3b and the fixed structure 4, the direction of displacement having a component parallel to the plane unfolded by the z and x-tilt axes and not intersecting the y-tilt axis. The displacement is, once again, adjusted by the setting screws 10.

The tie member 3c is disposed such that the point of contact between the tie member 3c and the supporting frame 2 lies in the plane unfolded by the x-tilt axis and the y-tilt axis. The translational mobility of the tie member 3c is in this case orientated perpendicular to the plane unfolded by the x and y-tilt axes. The adjustment of the z-tilt angle is effected by displacement of the point of contact between the tie member 3c and the fixed structure 4, the direction of displacement having a component parallel to the plane unfolded by the x and y-tilt axes and not intersecting the z-tilt axis. The displacement is in this case likewise adjusted by the setting screws 10.

The tie members 3a, 3b, 3c can be very different in design, but always have three rotational mobilities and one translational mobility in common. The rotational mobilities do not, however, necessarily have to be related to the point of contact between tie member 3a, 3b, 3c and supporting frame 2. In this type of rotational mobility, the point of contact between tie member 3a, 3b, 3c and supporting frame 2 would perform a swivel motion, since the fulcrum of this rotational mobility would no longer lie at the point of contact.

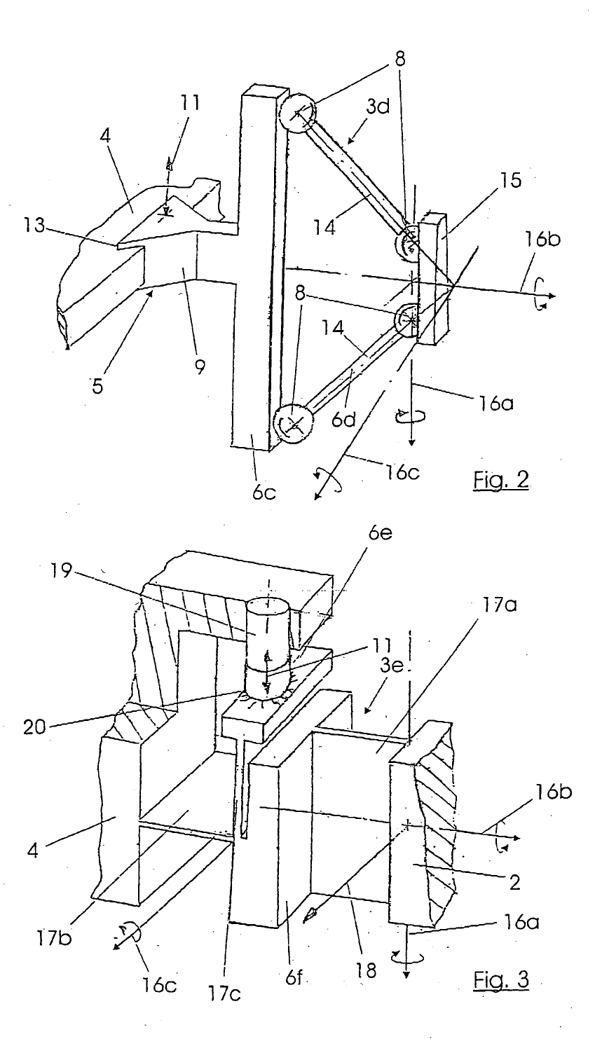

FIG. 2 shows a tie member 3d of this kind having two part-elements 6c and 6d, which are joined together by two ball joints 8. The elongated part-element 6c is connected to the fixed structure 4 by a dovetailed sliding block 9—as already represented in FIG. 1. The part-element 6e has two rods 14, which are fastened by two ball joints 8, via a contact plate 15, to the supporting frame 2. A direct connection to the supporting frame 2, without contact plate 15, is also, of course, conceivable. In this case, the contact region of the supporting frame 2 between the ball joint contact points may be regarded as part of the tie member 3d.

In the case of this tie member 3d, the axes of the rotational mobilities 16a, 16b and 16c do not intersect at any point. The vertical rotation axis 16a passes through the center points 6f the two ball joints 8 on the contact plate 15. The horizontal rotation axis 16b lies in the plane unfolded by the two rods 14, on the angle bisector between the rods 14. The horizontal rotation axis 16c passes through the point of intersection of the extensions (indicated in dashed representation) of the rods 14 perpendicular to the plane unfolded by the two rods 14.

The tie members 3d must in this case be fitted such that their points of contact with the supporting frame 2 (here the ball joints 8 on the contact plate 15) lie respectively in the plane respectively unfolded by the two tilt axes x, y, z (see FIG. 1) which are not adjusted by the respective tie member 3d.

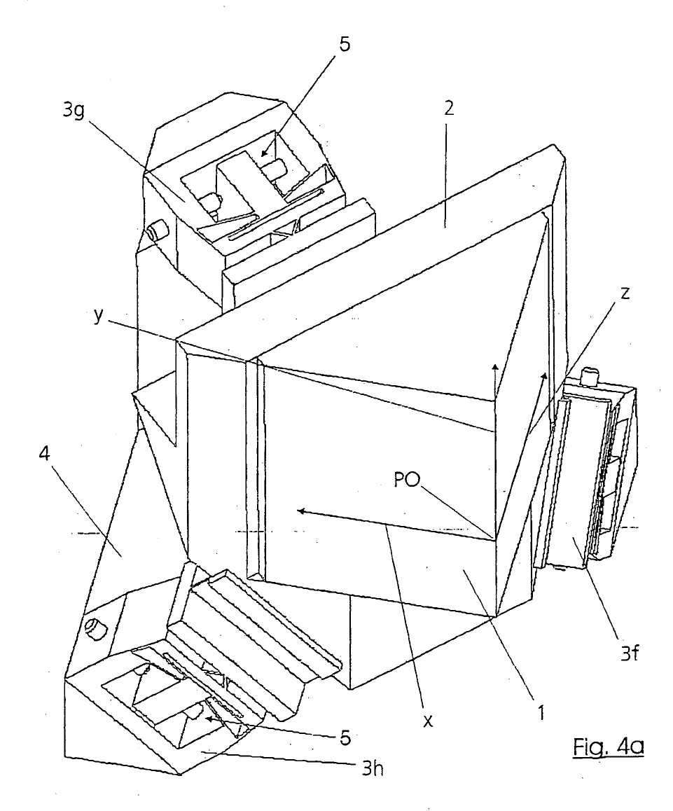

FIG. 3 shows a tie member 3e, which is constructed with solid state joints or spring joints 17. In a simple and advantageous manner, this tie member 3e can be made in monolithic construction. A leaf spring 17a connects a part-element 6f of the tie member 3e to the supporting frame 2 and permits on the supporting frame 2 a translation in the direction of an axis 18 and rotations about the axes 16a, 16b and 16c relative to the part-element 6f. Whilst a leaf spring 17b connects the part-element 6f to the fixed structure 4, a leaf spring 17c creates the connection of the part-element 6f to an actuator 19, which is fixedly mounted in the fixed structure 4.

The actuator 19, in rest position, secures the leaf spring 17c by its end and, for the adjustment of a tilt angle, imparts a displacement in the specified arrow direction 11 to a part-element 6e of the tie member 3e, which part-element is connected to the leaf spring 17c. The part-element 6e possesses, for this purpose, a contact face 20 for transmitting the displacement of the actuator 19 to the part-element 6e.

The rotation axis 16c passes through the instantaneous center of rotation obtained from the point of intersection of the center lines of the leaf springs 17b and 17c.

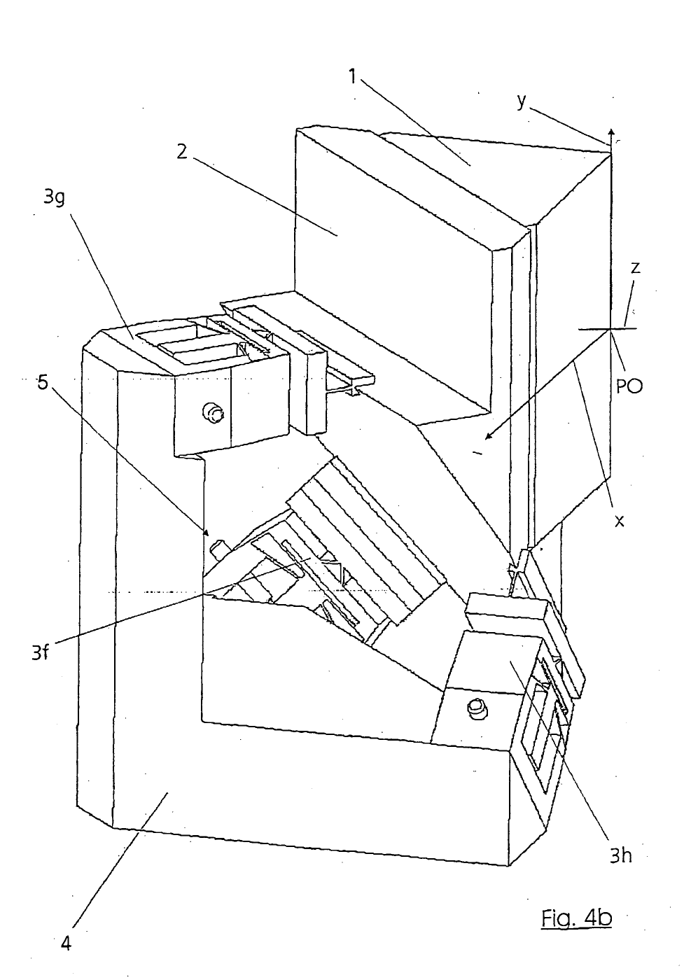

In FIGS. 4a and 4b, a further constructional embodiment of the invention is represented, in which an optical element—in this case a prism 1—can be tilted about three tilt axes x, y, z intersecting at a point PO.

The prism 1 is mounted in the supporting frame 2, which is connected to the fixed structure 4 by three tie members 3f, 3g and 3h. Here too, the fixed structure 4 can be connected to a housing of a projection lens 4a (indicated only in dashed representation, for example in FIG. 1). Integrated in each tie member 3f, 3g, 3h there is an adjusting mechanism 5, which allows tilting by a respective angle. The prism 1 can thus be tilted, by adjustment of the tie member 3f, about the tilt axis x, with the tie member 3g about the tilt axis y and with the tie member 3h about the tilt axis z.

Generally, each tie member 3f, 3g, 3h, in the contact with the supporting frame 2, must possess a translational mobility and three rotational mobilities, a rotational mobility being alternatively replaceable by a swivel mobility in the contact with the supporting frame 2.

The point of contact of the tie member 3f with the supporting frame 2 lies in the plane unfolded by the two tilt axes which are adjusted by means of the tie members 3g and 3h. The translational mobility of the tie member 3f stands perpendicular to this plane.

The point of contact of the tie member 3g with the supporting frame 2 lies in the plane unfolded by the two tilt axes which are adjusted by means of the tie members 3h and 3f. The translational mobility of the tie member 3g stands perpendicular to this plane.

The point of contact of the tie member 3h with the supporting frame 2 lies in the plane unfolded by the two tilt axes which are adjusted by means of the tie members 3f and 3g. The translational mobility of the tie member 3h stands perpendicular to this plane.

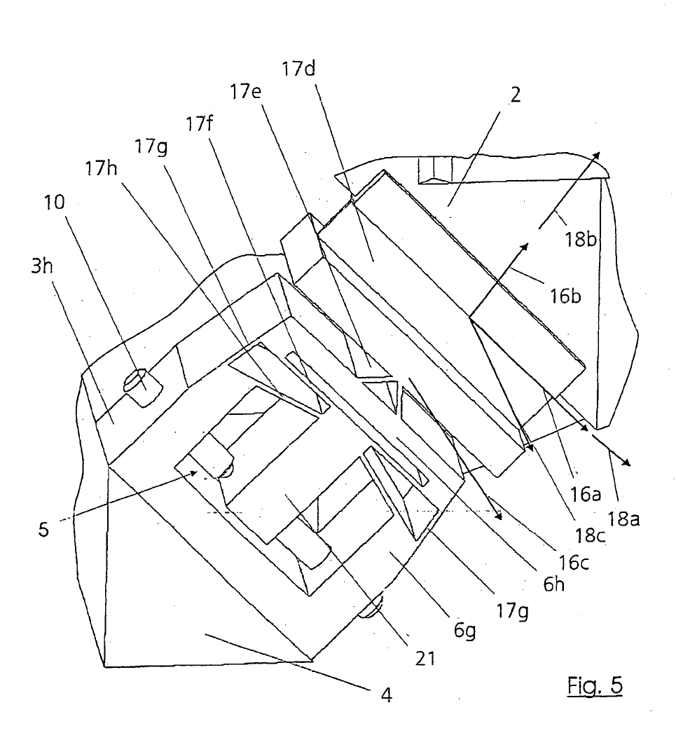

FIG. 5 shows the tie member 3h in enlarged representation. In the cited example, the translation along an axis 18c and the rotations about the rotation axis 16a and about the rotation axis 16b is enabled by a leaf spring 17d, which is flexible in these directions. For the third rotation or swivel motion, leaf springs are arranged as a “leaf spring four-bar mechanism” 17e, so that, at the instantaneous center of rotation of this “leaf spring four-bar mechanism”, a rotational mobility about the rotation axis 16c and thus a corresponding swivel mobility in the contact with the supporting frame 2 is obtained.

If the adjusting mechanism 5 is just not tilted, the translational mobilities should be secured along the axes 18a and 18b by the tie member 3h in order, in combination with the other two tie members 3f, 3g, to bear the supporting frame 2 together with the prism 1 in a statically determinate manner.

Each of the connecting members 3f, 3g, 3h has two part-elements or tie blocks 6g and 6h.

With the adjusting mechanism 5, the movable tie block 6h connected to the supporting frame 2 is moved relative to the fixed tie block 6g connected to the fixed structure 4.

The movable tie block 6h is here supported by leaf springs 17g in such a way relative to the fixed tie block 6g that it can travel along the axis 18a or rotate about an axis parallel to the rotation axis 16c.

Through movement of the movable tie block 6h relative to the fixed tie block 6g, the tilting motion of the supporting frame 2, together with the prism 1, is triggered.

An adjusting lever 21 is supported by leaf springs 17h in the fixed tie block 6g in such a way that it rotates about the point of intersection of the center lines of the leaf springs 17h, in a manner similar to that with the instantaneous center of rotation of a four-bar mechanism.

The adjusting lever 21 can be turned with the setting screws 10, the motion being transmitted with leaf springs 17f to the movable tie block 6h, which produces a tilting motion of the supporting frame 2 together with the prism 1.

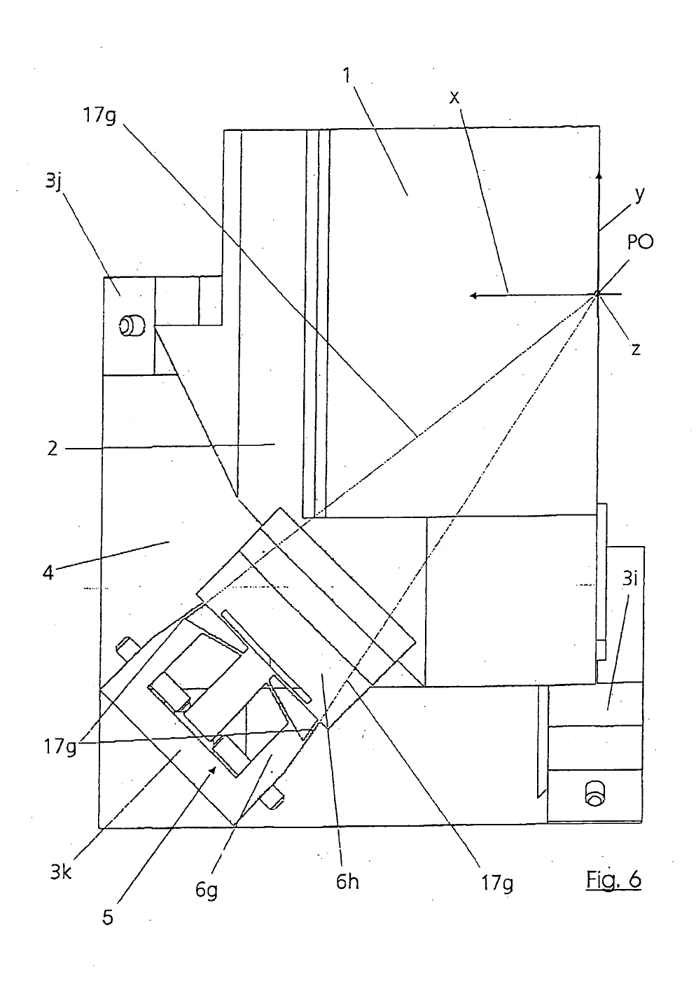

If the movable tie block 6h is mounted relative to the fixed tie block 6g and the fixed structure 4 in such a way that it swivels about the respectively desired x, y or z-tilt axis x, y, z, the pivot joint, formed by the leaf spring four-bar mechanism 17e, about the rotation axis 16c can be omitted (FIG. 6). Tie members 3i, 3j and 3k have in this case, in the contact with the supporting frame 2, one translational mobility and only two rotational mobilities or swivel mobilities.

In the contact with the supporting frame 2, the tie member 3k possesses for example, if its adjusting mechanism 5 is not actuated, one translational mobility along an axis 18c and, respectively, one rotational mobility about the rotation axis 16a and one about the rotation axis 16b.

The movable tie block 6h is in this case supported by the leaf springs 17g in the tie block 6g such that the instantaneous center of rotation of the movable tie block 6h lies on the desired tilt axis. For this, center lines 19 (indicated in dashed representation in FIG. 6) of the leaf springs 17g must intersect, for example, at the point PO or on the desired rotation axis.

In FIG. 6, this is represented, by way of example, for the tie member 3k and its desired tilt axis z.

The saving on the pivot or swivel joint about the rotation axis 16c, which saving produces an additional stiffening of the system, allows reduced susceptibility to unwanted vibrations of the prism 1.

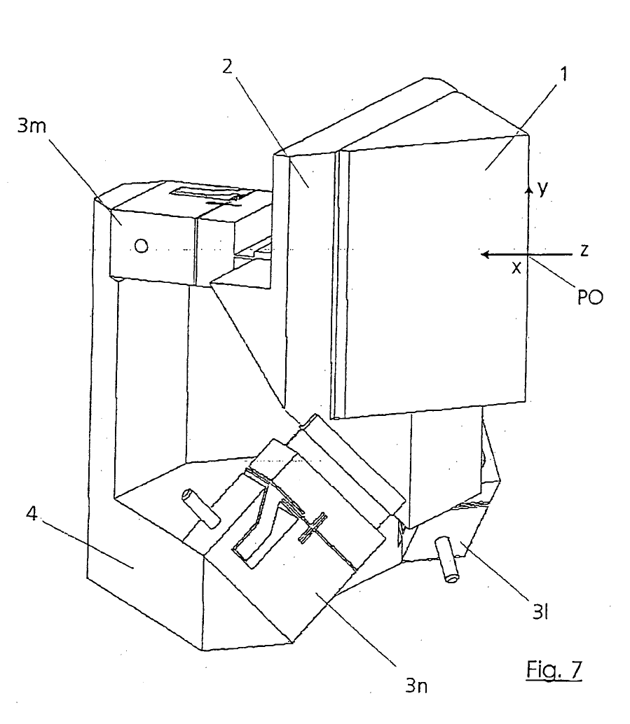

A further constructional embodiment based on the tie member 3e already represented in FIG. 3 is represented in FIG. 7, with tie members 31, 3m and 3n.

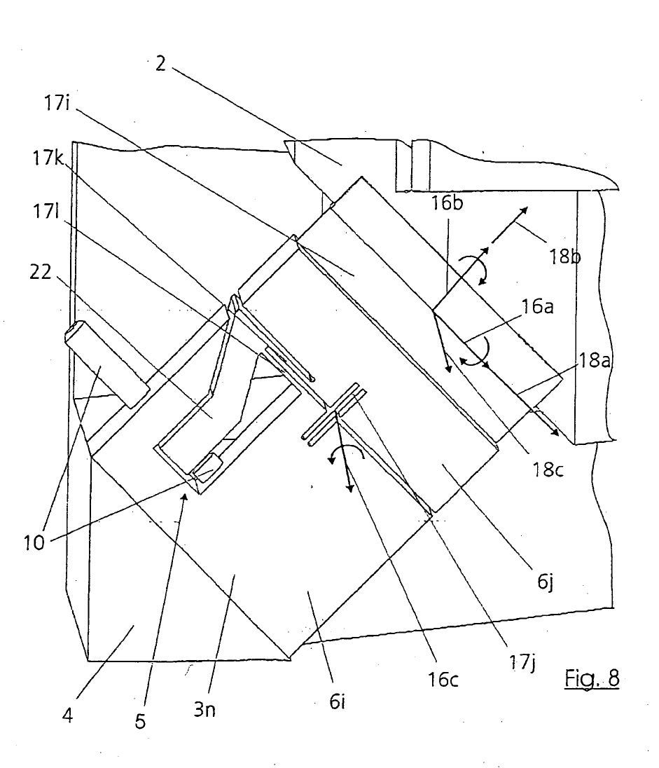

For example, in FIG. 8, in respect of the tie member 3n, a translational mobility along the axis 18c and rotational mobilities about the rotation axes 16a and 16b is enabled in the contact with the supporting frame 2 by a leaf spring joint 17i.

A leaf spring joint 17j, in combination with a leaf spring joint 17k, connects a movable tie block 6j to a fixed tie block 6i such that the movable tie block 6j, upon the actuation of the adjusting mechanism 5, can travel in a translatory motion along the axis 18a and rotate about the rotation axis 16c.

A tilting of the prism 1 about the tilt axis z through the point PO is then made up of this combination of displacement and rotation.

The displacement is transmitted by the setting screws 10 via an adjusting lever 22, which is fastened rotatably to the fixed tie block 6i with a leaf spring joint 17l, and with the leaf spring joint 17k, to the movable tie block 6j.

1. A device for manipulating the angular position of an object relative to a fixed structure, about three tilt axes intersecting at a point, wherein said object is connected to said fixed structure by three tie members, comprising respectively three rotational mobilities and one translational mobility, the angular position of said object being adjustable by, respectively, one of said tie members about, respectively, one of the three tilt axes.

2. The device as claimed in claim 1, wherein said object is mounted in a supporting frame, said supporting frame being connected to said fixed structure by said three tie members and the angular position of said supporting frame being adjustable by, respectively, one of said tie members about, respectively, one of the three tilt axes.

3. The device as claimed in claim 1 or 2, wherein the vectors of the respective translational mobilities of said three tie members are linearly independent from one another.

4. The device as claimed in claim 2, wherein said tie members, for the adjustment of one of the three tilt axes, are respectively disposed at least approximately such that their point(s) of contact with said object and with said supporting frame lie in the plane respectively unfolded by the tilt axes which are adjustable by the other two said tie members, and wherein the translational mobility of said respective tie member is orientated at least approximately perpendicular to said plane.

5. The device as claimed in claim 1 or 2, wherein, for the adjustment of one of the three tilt axes, the point(s) of contact between said respective tie members and said fixed structure are displaceable in such a way that, respectively, the direction of displacement comprises a component at least approximately parallel to the plane respectively unfolded by the tilt axes which are adjustable by the other two said tie members and does not intersect the tilt axis to be adjusted.

6. The device as claimed in claim 1, wherein for the adjustment of one of the three tilt axes, the respective said tie members comprise adjusting mechanisms for the translatory adjustment of at least one part-element of the respective tie members.

7. The device as claimed in claim 6, wherein each of said tie members comprises at least two part-elements, which are joined together by at least one joint element, one of said part-elements of the respective said tie member being fastened to said supporting frame by at least one said joint element, and said part-element facing away from said supporting frame being connected to said fixed structure and being movable therein, in a translatory motion, by said adjusting mechanisms.

8. The device as claimed in claim 7, wherein the motional direction of said adjusting mechanisms of said respective tie members is orientated approximately perpendicular to the respective translational mobility of said respective tie members.

9. The device as claimed in claim 6, wherein said adjusting mechanisms can be moved in a translatory motion by adjusting means.

10. The device as claimed in claim 7, wherein each of said tie members is aligned, with its axes running through the center points of said joint elements and of said adjusting mechanism, parallel to one of the tilt axes about which the angular position of said object and of said supporting frame is intended to be manipulated.

11. The device as claimed in claim 6, wherein said adjusting mechanisms are provided with sliding blocks.

12. The device as claimed in claim 11, wherein said sliding blocks are of dovetailed configuration.

13. The device as claimed in claim 11, wherein said sliding blocks comprise contact faces for transmitting the motion of said adjusting means to said sliding blocks.

14. The device as claimed in claim 13, wherein said adjusting means are configured in such a way as setting screws acting upon said contact faces of said sliding blocks that said sliding blocks are translatorily adjustable.

15. The device as claimed in claim 12, wherein said fixed structure comprises recesses, matched in shape and dimensions to said adjusting mechanisms, for receiving said adjusting mechanisms.

16. The device as claimed in claim 15, wherein said dovetailed sliding blocks can be introduced into said recesses in said fixed structure in such a way that they are translatorily adjustable by said setting screws.

17. The device as claimed in claim 7, wherein said joint elements are configured as ball joints.

18. The device as claimed in claim 7, wherein said joint elements are configured as hinges.

19. The device as claimed in claim 7, wherein said joint elements are configured as solid state joints.

20. The device as claimed in claim 18, wherein the axes of said hinges of each of said tie members are respectively disposed at least approximately parallel to the translatory motional direction of said adjusting mechanisms.

21. The device as claimed in claim 19, wherein said solid state joints are configured as leaf springs.

22. A device for manipulating the angular position of an optical element, disposed in a microlithographic projection lens, relative to a fixed structure about three tilt axes intersecting at a point, wherein said optical element is connected to said fixed structure by three tie members, comprising respectively at least two rotational mobilities and one translational mobility, the angular position of said optical element being adjustable by, respectively, one of said tie members about, respectively, one of the three tilt axes.

23. The device as claimed in claim 22, wherein said optical element is mounted in a supporting frame, said supporting frame being connected to said fixed structure by said three tie members and the angular position of the supporting frame being adjustable by, respectively, one of said tie members about, respectively, one of the three tilt axes.

24. The device as claimed in claim 22 or 23, wherein said optical element is configured as a mirror.

25. The device as claimed in claim 22 or 23, wherein said optical element is configured as a prism, a beam-splitting prism or a lens.

26. The device as claimed in claim 22 or 23, wherein said fixed structure is connected to a housing of said projection lens.

27. The device as claimed in claim 22 or 23, wherein the vectors of the respective translational mobilities of said tie members are linearly independent from one another.

28. The device as claimed in claim 23, wherein said tie members, for the adjustment of one of the three tilt axes, are respectively disposed at least approximately such that their point(s) of contact with said supporting frame lie in the plane respectively unfolded by the tilt axes which are adjustable by the other said two tie members, and wherein the translational mobility of said respective tie member is orientated at least approximately perpendicular to said plane.

29. The device as claimed in claims 22 or 23, wherein, for the adjustment of one of the three tilt axes, the point (s) of contact between said respective tie members and said fixed structure are displaceable in such a way that, respectively, the direction of displacement comprises a component at least approximately parallel to the plane respectively unfolded by the tilt axes which are adjustable by the other said two tie members and does not intersect the tilt axis to be adjusted.

30. The device as claimed in claims 22 or 23, wherein, for the adjustment of one of the three tilt axes, the respective said tie members have adjusting mechanisms for the translatory adjustment of at least one part-element of the respective said tie members.

31. The device as claimed in claim 23, wherein each of said tie members has at least two part-elements, which are joined together by at least one joint element, one of said part-elements of the respective said tie member being fastened to said supporting frame by at least one said joint element, and said part-element facing away from said supporting frame being connected to said fixed structure and being movable therein, in a translatory motion, by said adjusting mechanisms.

32. The device as claimed in claim 31, wherein the motional direction of said adjusting mechanisms of said respective tie members of said adjusting mechanisms of said respective tie members is orientated approximately perpendicular to the respective translational mobility of said respective tie members.

33. The device as claimed in claim 30, wherein said adjusting mechanisms can be moved in a translatory motion by adjusting means.

34. The device as claimed in claim 31, wherein each of said tie members is aligned, with its axes running through the center points of said joint elements and of said adjusting mechanism, parallel to one of the tilt axes about which the angular position of said supporting frame with said optical element is intended to be manipulated.

35. The device as claimed in claim 30, wherein said adjusting mechanisms are provided with sliding blocks.

36. The device as claimed in claim 35, wherein said sliding blocks are of dovetailed configuration.

37. The device as claimed in claim 35, wherein said sliding blocks have contact faces for transmitting the motion of said adjusting means to said sliding blocks.

38. The device as claimed in claim 35, wherein said adjusting means are configured in such a way as setting screws acting upon the contact faces of said sliding blocks that said sliding blocks are translatorily adjustable.

39. The device as claimed in claim 38, wherein said fixed structure has recesses, matched in shape and dimensions to said adjusting mechanisms, for receiving said adjusting mechanisms.

40. The device as claimed in claim 39, wherein said dovetailed sliding blocks can be introduced into said recesses in said fixed structure in such a way that they are translatorily adjustable by said setting screws.

41. The device as claimed in claim 31, wherein said joint elements are configured as ball joints.

42. The device as claimed in claim 31, wherein said joint elements are configured as hinges.

43. The device as claimed in claim 31, wherein said joint elements are configured as solid state joints.

44. The device as claimed in claim 42, wherein the axes of said binges of each of said tie members are respectively disposed at least approximately parallel to the translatory motional direction of said adjusting mechanisms.

45. The device as claimed in claim 43, wherein said solid state joints are configured as leaf springs.

46. The device as claimed in claim 1 or 22, wherein said tie members comprise respectively three rotational mobilities at the most.
